(19) United States
(12) Patent Application Publication
(10) Pub. No.: US 2004/0140143 A1
(43) Pub. Date: Jul. 22, 2004

(54) Following distance control apparatus

(75) Inventors: Minoru Saeki, Seto-shi (JP); Hironori Miyakoshi, Novi, MI (US); Hiroaki Fujinami, Susono-shi (JP); Koichi Hara, Susono-shi (JP); Masato Seki, Susono-shi (JP); Kunihito Sato, Mishima-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/745,859

(22) Filed: Dec. 29, 2003

(30) Foreign Application Priority Data
Jan. 17, 2003 (JP) 2003-009984

(51) Int. Cl. B60R 21/00

(52) U.S. Cl. 180/271

(57) ABSTRACT

A follow distance control apparatus controls a follow distance without giving an uncomfortable feel to a driver during a deceleration control regardless of a selected control mode. A front-vehicle running ahead of an own-vehicle is detected by a sensor such as a radar. A deceleration apparatus, which decelerates the own-vehicle, is controlled by a controller based on an output signal of the sensor. The controller controls the deceleration apparatus according to selected one of a short distance control mode and a long distance control mode. In the short distance control mode, an actual value of the following distance is controlled to be shorter. In the long distance control mode, the actual value of the following distance is controlled to be longer. The controller also controls the deceleration apparatus so that, when the long distance control mode is selected, an overshoot that is a phenomenon in which the own-vehicle moves excessively toward a near side of the front-vehicle is permitted more than when the short distance control mode is selected.

### BACKGROUND OF THE INVENTION

1. Field of the Invention

The present invention relates to a control of a vehicle and, more particularly to a technique for controlling a following distance, which is a distance between an own-vehicle and a front-vehicle that is running ahead of the own-vehicle, by controlling a movement of the own-vehicle.

2. Description of the Related Art

A following distance control apparatus for controlling a following distance, which is a distance between an own-vehicle and a front-vehicle that is running ahead of the own-vehicle, by controlling the movement of the own-vehicle is known. Such a following distance control apparatus generally comprises: (a) a sensor provided in the own-vehicle to detect a front-vehicle; (b) a deceleration apparatus for decelerating the own-vehicle; and (c) a controller for performing the deceleration control of the own-vehicle by controlling the deceleration apparatus based on a output signal of the above-mentioned sensor. Japanese Laid-Open Patent Application No. 2002-79846 discloses a conventional example of such a following distance control apparatus.

In the conventional example disclosed in the above-mentioned patent document, a running mode of the own-vehicle is classified into a plurality of modes including a “merge mode” and a “follow mode”. The “merge mode” is for controlling a following distance so as to equalize an actual value of the following distance to a target value of the following distance in a state where the sensor is tracking the front-vehicle but a deviation of the actual value from the target value is large or a relative speed between the own-vehicle and the front-vehicle is large. On the other hand, the “follow mode” is for controlling a following distance in a state where the actual value of the following distance is already close to the target value thereof.

According to the above-mentioned conventional example, it is preferable, in the merge mode, to match the control characteristics of the following distance with a driving operation feeling of the driver of the own-vehicle. A description will be given below of the driving operation feeling. It is known that an ordinary driver tends to gradually increase an actual value of the following distance to the target value so as to return the own-vehicle to a position of the target following distance after decreasing the actual value of the following distance to be smaller than the target value so that the own-vehicle approaches the front-vehicle beyond the position corresponding to the target following distance when the ordinary driver performs by himself or herself a process from a first detection of a front-vehicle until causing the actual value of the following distance to be equal to the target value of the following distance.

On the other hand, in the follow mode, it is desirable to give greater importance on a running stability (for example, vehicle speeds do not fluctuate) of each of a plurality of vehicles including the own-vehicle and the front-vehicle when the vehicles run in a column.

Based on the above-mentioned knowledge, according to the conventional example, a run control of an own-vehicle is performed in the follow mode so that an actual value of a following distance does not become smaller than a target value, that is, an overshoot doe not occur. On the other hand, in the merge mode, the run control of an own-vehicle is performed so that an actual value of a following distance reaches a target value after the actual value of the following distance has become smaller than the target value, that is, after an overshoot has occurred.

That is, in a transition period from a state where the actual value of the following distance is off from the target value until the actual value reaches the target value, an overshoot is prohibited in the follow mode while an overshoot is intentionally realized in the merge mode.

The inventors conducted a research and development on a following distance control apparatus of a type that controls a deceleration apparatus in accordance with selected one of a short distance control mode for controlling an actual value of a following distance shorter and a long distance control mode for controlling an actual value of a following distance longer.

In a case in which a deceleration of an own-vehicle is required so as to follow a front-vehicle, it is desirable that a run state of the own-vehicle established by a deceleration control of the own-vehicle performed by a deceleration apparatus does not give an uncomfortable feel to the driver of the own-vehicle.

When the deceleration control is performed according to the short distance control mode, there is a less margin in a following distance than that according to the long-distance control mode. Therefore, if the deceleration control is performed in a manner that an overshoot, which is a phenomenon where the own-vehicle excessively approaches the front-vehicle, is permitted, there is a tendency that the own-vehicle approaches the front-vehicle too much.

Therefore, when the deceleration control is performed according to the short distance control mode, it is desirable from a driver's viewpoint to perform the deceleration control so that an overshoot does not occur.

On the other hand, when the deceleration control is performed according to the long distance control mode, there is a greater margin in a following distance than the case where the deceleration control is performed according to the short distance control mode. Therefore, if the deceleration control is performed in a manner that an overshoot, which is a phenomenon where the own-vehicle excessively approaches the front-vehicle, does not occur, it tends to give the driver a feel that the deceleration of the own-vehicle is unnecessarily large since there is a large tendency of deceleration of the own-vehicle although there is a considerable margin in the following distance.

Accordingly, when the deceleration control is performed according to the long distance control mode, it is desirable from a driver's viewpoint to perform the deceleration control so-that an overshoot is permitted

That is, the inventor found that it is desirable from a driver's viewpoint to change the characteristics of the deceleration control (for example, whether it is sensitive or insensitive to a change in a run environment) in response to a kind of mode selected from a plurality of control modes that are set in relation with a length of a target following distance. This discovery is not disclosed in the above-mentioned patent document, Japanese Laid-Open Patent Application No. 2002-79846.

### SUMMARY OF THE INVENTION

It is a general object to provide an improved and useful follow distance control apparatus in which the above-mentioned problems are eliminated.

A more specific object of the present invention is to provide a follow distance control apparatus which can control a follow distance without giving an uncomfortable feel to a driver of a vehicle equipped with the follow distance control apparatus during a deceleration control being performed to achieve a target follow distance, regardless of a selected control mode that is selected from among a plurality of control modes set in relation with a length of the target follow distance.

There is provided according to one aspect of the present invention a following distance control apparatus for controlling a following distance, which is a distance between an own-vehicle and a front-vehicle running ahead of the own-vehicle, by controlling a movement of the own-vehicle, the following distance control apparatus comprising: a sensor provided in the own-vehicle so as to detect the front-vehicle; a deceleration apparatus that decelerates the own-vehicle; and a controller that controls the deceleration apparatus based on an output signal of the sensor, wherein the controller controls the deceleration apparatus according to selected one of a short distance control mode and a long distance control mode, the short distance control mode for controlling an actual value of the following distance to be shorter, the long distance control mode for controlling the actual value of the following distance to be longer; and the controller also controls the deceleration apparatus so that, when the long distance control mode is selected, an overshoot is permitted more than when the short distance control mode is selected, the overshoot being a phenomenon in which the own-vehicle moves excessively toward a near side of the front-vehicle.

According to the above-mentioned following distance control apparatus, the deceleration control of the own-vehicle is performed so that, when the long distance control mode for controlling an actual value of the following distance to be longer is selected, an overshoot that is a phenomenon in which the own-vehicle moves excessively toward a near side of the front-vehicle is permitted more than when the short distance control mode for controlling the actual value of the following distance to be shorter is selected.

Thus, according to the above-mentioned following distance control apparatus, when the long distance control mode is selected, a tendency of giving an uncomfortable feel due to an excessive degree of deceleration of the own-vehicle with respect to a following distance having a relatively large margin is suppressed. For example, a relationship between a magnitude of the margin of the following distance and a way of deceleration (a deceleration slope) of the own-vehicle is close to one which the driver of the own-vehicle feels natural. As a result, an uncomfortable feel given to the driver with respect to the deceleration control is reduced.

Further, according to the above-mentioned following distance control apparatus, when the long time control mode is selected, a ride comfort is improved since the deceleration of the own-vehicle is moderated.

On the other hand, when the short distance control mode is selected, a tendency of the own-vehicle excessively approaching the front-vehicle is suppressed, which results in an improvement in a sense of ease of the driver.

In the following distance control apparatus according to the present invention, the deceleration apparatus may include at least one of a brake force increasing apparatus for increasing a brake force of the own-vehicle and a drive power decreasing apparatus for decreasing a drive power of the own-vehicle. Additionally, the brake force increasing apparatus may include a brake that controls rotation of a wheel of the own-vehicle. The brake may be of a friction type, a pneumatic type or a regenerative type.

Additionally, in the following distance control apparatus according to the present invention, the own-vehicle comprises: an engine as a power source, an amount of intake air thereto being controlled in response to a degree of opening of a throttle valve; and a transmission that transmits an output of the engine to a drive wheel of the own-vehicle, a change gear ratio thereof being variable, wherein the drive power decreasing apparatus includes at least one of means for decreasing the degree of opening of the throttle valve and means for changing the change gear ratio so that a level of braking action generated by the engine increases.

Here, the “braking action generated by the engine” means an action that restricts rotation of the wheel by utilizing, for example, a pumping loss generated in the engine in which a piston is reciprocated in a state where an intake line connected to a combustion chamber of the engine is closed.

Additionally, in the following distance control apparatus according to the present invention, the short distance control mode and the long distance control mode may be set in relation to a target value of a following time that is a predicted time period from a time when the front-vehicle passes a certain point until a time when the own-vehicle passes the certain point; the short distance control mode may include a short time control mode for controlling the following distance by setting the target value of the following time to a small value; and the long distance control mode may include a long time control mode for controlling the following distance by setting the target value of the following time to a large value.

The above-mentioned “following distance” is a physical amount, which represents a degree of separation of the own-vehicle to the front-vehicle by a dimension of distance, while the “following time” is a physical amount, which represents the degree of separation by a dimension of time period. The following time can be obtained, for example, by dividing the following distance by a vehicle speed of the own-vehicle. The target value of the following time is a physical amount that can be commonly used over an entire range in which the vehicle speed of the own-vehicle can vary. Therefore, when it is required to change the target following distance in response to the vehicle'speed of the own-vehicle, availability and versatility of the following time is higher than the following time with which the target value must be set for each vehicle speed.

In the following distance control apparatus according to the present invention, the controller may include slope control means for controlling a slope of a deceleration of the own-vehicle so that the slope has a gentle inclination when the long distance control mode is selected, and the slope has a steep inclination when the short distance control mode is selected.

If the deceleration apparatus of the own-vehicle is controlled based on a control deviation, which is a difference between a target value and an actual value of the following distance or the following time, the deceleration control is performed with a limited overshoot when the own-vehicle is decelerated sensitive to the control deviation, that is, when the own-vehicle is decelerated with a large inclination of the deceleration slope with respect to the control deviation. On the other hand, if the own-vehicle is decelerated insensitive to the control deviation, that is, if the own-vehicle is decelerated with a small inclination of the deceleration slope, an over shoot is easily induced which results in an execution of the deceleration control.

Based on such knowledge, in the following distance control apparatus according to the above-mentioned invention, the deceleration slope of the own-vehicle is controlled so that the deceleration slope has a gentle inclination when the long distance control mode is selected, and the deceleration slope has a steep inclination when the short distance control mode is selected.

Additionally, in the above-mentioned following distance control apparatus, the slope control means may include: target slope determining means for determining a target slope, which is a target value of the deceleration slope, based on a following time deviation relating amount that relates to a difference between an actual value and a target value of a following time that is a predicted time period from a time when the front-vehicle passes a certain point until a time when the own-vehicle passes the certain point so that an inclination of the target slope decreases as a tendency of the own-vehicle separating from the front-vehicle increases and the inclination of the target slope increases as the tendency of the own-vehicle approaching the front-vehicle increases; and shifting means for performing at least one of a separating shift and an approaching shift prior to the determination of the target slope by the target slope determining means, the separating shift for shifting the actual value of the following time deviation relating amount in a direction in which the own-vehicle apparently goes away from the front-vehicle when the long distance control mode is selected, the approaching shift for shifting the actual value of the following time deviation relating amount in a direction in which the own-vehicle apparently goes close to the front-vehicle when the short distance control mode is selected.

According to the above-mentioned following distance control apparatus, prior to the determination of the target slope based on the following time deviation relating amount, at least one of the separating shift, which shifts the actual value of the following time deviation relating amount in a direction in which the own-vehicle apparently goes away from the front-vehicle when the long distance control mode is selected, and the approaching shift, which shifts the actual value of the following time deviation relating amount in a direction in which the own-vehicle apparently goes close to the front-vehicle when the short distance control mode is selected, is performed.

The target slope which is a target value of the deceleration slope of the own-vehicle is determined based on the following time deviation relating amount so that an inclination of the target slope decreases as a tendency of the own-vehicle separating from the front-vehicle increases and the inclination of the target slope increases as the tendency of the own-vehicle approaching the front-vehicle increases.

Accordingly, the shift of the actual value of the following time deviation relating amount in the direction in which the own-vehicle apparently goes away from the front-vehicle means that the target slope is determined to be a value smaller than an original value. In contrast, the shift of the actual value of the following time deviation relating amount in the direction in which the own-vehicle apparently goes close to the front-vehicle means that the target slope is determined to be a value larger than the original value.

Thus, according to the following distance control apparatus according to the above-mentioned invention, at least one of the determination of the target slope to be a smaller value than the original value when the long distance control mode is selected and the determination of the target slope to be a larger value than the original value when the short distance control mode is selected.

In the following distance control apparatus according to the above-mentioned invention, the following time deviation relating amount may include an amount of difference between the actual value and the target value of the following time.

Additionally, in the following distance control apparatus according to the above-mentioned invention, the following time deviation relating amount may include a following time deviation ratio that is a ratio of an amount of difference between the actual value and the target value of the following time to a target value of the amount of difference.

Further, the following distance control apparatus according to the present invention may further comprise means for performing the control of the following distance so that an undershoot, which is a phenomenon of the vehicle going excessively away from the front-vehicle, is not permitted.

If the undershoot of the following distance occurs at the time of control of the following distance, an excessive following distance is provided between the own-vehicle and the front-vehicle. Accordingly, there is a problem for the own-vehicle that a possibility that another vehicle breaks into a position between the own-vehicle and the front-vehicle is increased. Moreover, for a following-vehicle, which follows the own-vehicle, there is a problem in that the own-vehicle tends to approach the following-vehicle too much.

Base on such knowledge, according to the above-mentioned following distance control apparatus, the following distance control is performed so that an under shoot is not permitted.

Other objects, features and advantages of the present invention will become more apparent from the detailed description when read in conjunction with the accompanying drawings.

### BRIEF DESCRIPTION OF THE DRAWINGS

FIG. 1 is a block diagram showing a hardware structure of a follow distance control apparatus according to a first embodiment of the present invention;

FIG. 2 is an illustration showing an example where one front-vehicle exists within a detection zone of a radar of an own-vehicle;

FIG. 3 is a flowchart showing conceptually contents of a deceleration control program executed by a computer of a following distance ECU shown in FIG. 1;

FIG. 4 is a graph showing a relationship between a final following time deviation ratio Gtdep and a deceleration slope dG used in the deceleration control program shown in FIG. 3;

FIG. 5 is a graph showing a change in a target deceleration GT with respect to time in a series of controls executed by the deceleration control program shown in FIG. 3;

FIG. 6 is an illustration for explaining that deceleration characteristics of the control performed by execution of the deceleration control program shown in FIG. 3 differ from a short time control mode to a long time control mode;

FIG. 7 is a graph for explaining an effect of a shift in a relationship between the target deceleration GT and an original following time deviation ratio Tdep;

FIG. 8 is a graph for explaining a relationship between a control mode and a deviation ratio shift amount Dlevel;

FIG. 9 is a flowchart which shows conceptually the contents of a deceleration control program executed by a computer of a following distance control apparatus according to a second embodiment;

FIG. 10 is a graph showing a change in a target deceleration GT with respect to time in a series of controls executed by the deceleration control program shown in FIG. 9;

FIG. 11 is a flowchart which shows conceptually the contents of a deceleration control program executed by a computer of a following distance ECU in a following distance control apparatus according to a third embodiment of the present invention;

FIG. 12 is a flowchart which shows conceptually the contents of the deceleration control program executed by a computer of a following distance ECU in a following distance control apparatus according to a fourth embodiment of the present invention;

FIG. 13 is a graph for explaining an example of a temporal change in a real deceleration GR on the assumption that an initial real deceleration GR is zero;

FIG. 14 is a graph for explaining an example of a temporal change in a real deceleration GR on the assumption that an initial real deceleration GR is zero;

FIG. 15 is a graph for explaining an an example of a temporal change in a real deceleration GR during a deceleration control;

FIG. 16 is a flowchart which shows conceptually the contents of the deceleration control program executed by a computer of a following distance ECU in a following distance control apparatus according to a fifth embodiment of the present invention;

FIG. 17 is a flowchart which shows conceptually the contents of the deceleration control program executed by a computer of a following distance ECU in a following distance control apparatus according to a sixth embodiment of the present invention;

FIG. 18 is a graph for explaining a relationship between a vehicle speed Vn and a brake control permission distance D0;

FIG. 19 is a flowchart which shows conceptually the contents of the deceleration control program executed by a computer of a following distance ECU in a following distance control apparatus according to a seventh embodiment of the present invention;

FIG. 20 is a time chart which conceptually represents a temporal change in various status amounts from a start time to an end time of a series of deceleration control operations; and

FIG. 21 is a flowchart which shows conceptually the contents of the deceleration control program executed by a computer of a following distance ECU in a following distance control apparatus according to an eighth embodiment of the present invention.

### DETAILED DESCRIPTION OF THE PREFERRED EMBODIMENTS

A description will be given below, with reference to the drawings, of some embodiments of the present invention.

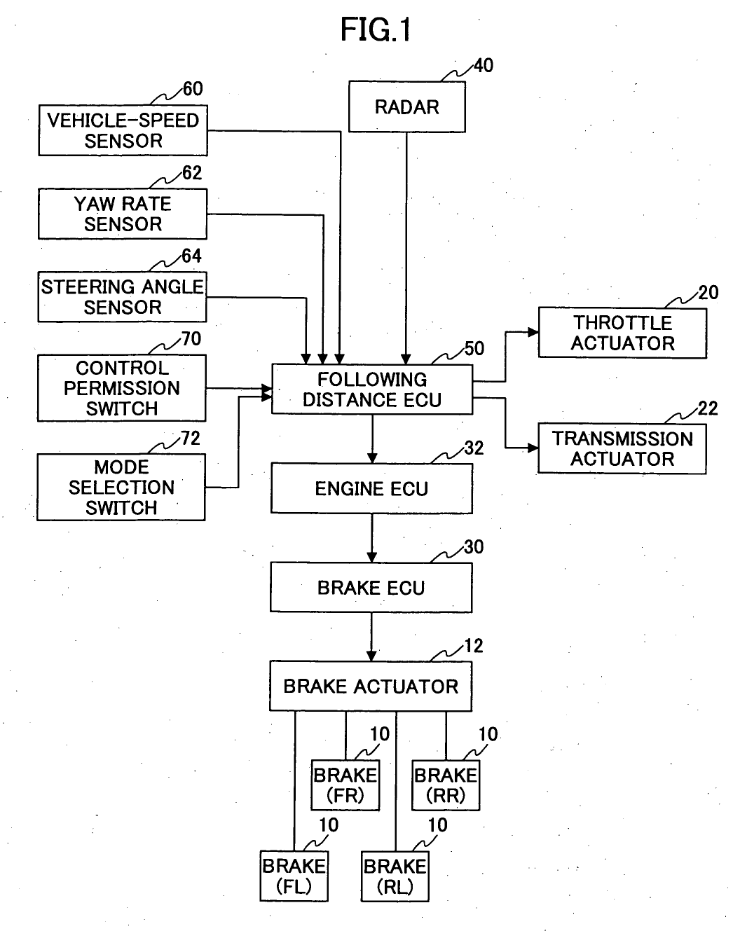

FIG. 1 is a block diagram showing a hardware structure of a follow distance control apparatus according to a first embodiment of the present invention.

The following distance control apparatus shown in FIG. 1 is equipped on a vehicle. The vehicle is driven by an engine (may also be an electric motor) as a power source producing a drive power that is transmitted to a plurality of drive wheels via a transmission (a multi-step type or a stepless type).

The vehicle is equipped with a brake 10 (for example, a friction type, a regenerative-braking type, etc. ) which brakes each of a plurality of wheels including a plurality of drive wheels. The wheels may include left and right front wheels and left and right rear wheels. In FIG. 1, “FL” indicates the front left wheel; “FR” indicates the front right wheel; “RL” indicates the rear left wheel; and “RR” indicates right rear wheel. The vehicle is equipped with a brake actuator 12 (for example, a motor drive type, an electromagnetic force control type, etc. ) which controls the brake 10 of each wheel electrically.

The engine is equipped with a throttle in an intake manifold thereof so that an output of the engine is changed by a degree of opening of the throttle. The degree of opening of the throttle is electrically controllable by a throttle actuator 20 (for example, an electric motor).

In the transmission, a change gear ratio of an input shaft to an output shaft is changed. In order to control the change gear ratio electrically, a transmission actuator 22 (for example, a solenoid) is provided.

The vehicle is equipped with a brake ECU (electronic control unit) 30 which controls each brake 10 through the brake actuator 12, and further equipped with an engine ECU 32 which controls the engine and the transmission through the throttle actuator 20 and the transmission actuator 22, respectively. Each of the brake ECU 30 and the engine ECU 32 is constituted mainly by a computer containing CPU, ROM and RAM. This is the same for other ECUs mentioned below.

As shown in FIG. 1, the following distance control device according to the present embodiment is equipped with a radar 40 as a sensor which detects a front vehicle ahead of the own-vehicle which is equipped with the radar 40. The radar 40 is an apparatus that detects a distance between a target object and the own-vehicle and a relative direction of the own-vehicle with respect to the target object by radiating an electromagnetic wave (including light, sound, etc. ) and receiving the electromagnetic wave reflected by the target object in a detection zone of the radar 40.

The radar 40 covers the whole region of the generally fan-shaped detection zone by reciprocally swinging an electromagnetic wave beam in directions crossing the direction of travel of the beam so as to scan the front of the radar 40.

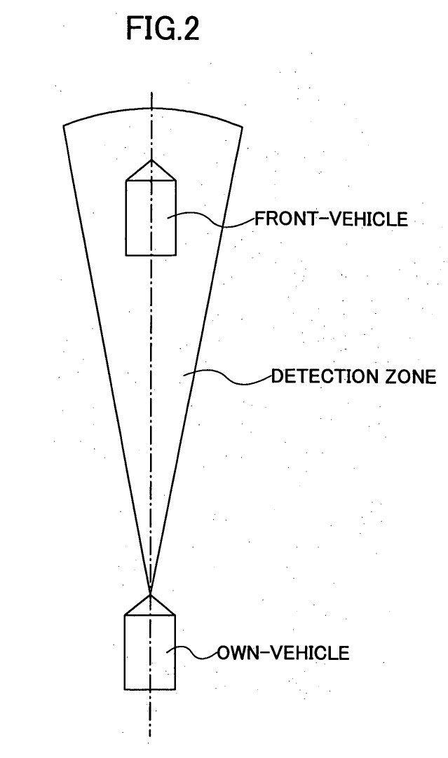

When the target object detected by the radar 40 is a front-vehicle, the radar 40 will detect a following distance, which is a distance between the own-vehicle and the front-vehicle, and the relative direction of the front-vehicle with respect to the own-vehicle. FIG. 2 shows an example where one front-vehicle exists within the detection zone of the radar 40 of the own-vehicle.

An electromagnetic wave radiated by the radar 40 can be selected from, for example, a laser light (laser beam) and a millimetric wave (extremely high frequency wave). In the meantime, generally all vehicles have a pair of reflectors which are separated on left and right sides of a rear face thereof. Using the reflected wave from the pair of reflectors of each vehicle, the radar 40 can discriminate each vehicle from other vehicles in the detection zone thereof.

A following distance ECU 50 is provided in the following distance control apparatus as shown in FIG. 1 so as to control the movement of the own-vehicle based on the output signal of the radar 40 so that the following distance between a front-vehicle and the own vehicle becomes close to a target distance.

The following distance ECU 50 basically controls a braking force through the brake ECU 30 and the brake actuator 12 for deceleration of the own-vehicle, and, on the other hand, controls a degree of opening of the throttle and a change gear ratio through the engine ECU 32, the throttle actuator 20 and the transmission actuator 22 for acceleration of the own-vehicle.

As shown in FIG. 1, the following distance control device according to the present embodiment is further equipped with a vehicle speed sensor 60, a yaw rate sensor 62 and a steering angle sensor 64.

The vehicle speed sensor 60 is a sensor which detects a vehicle speed of an own-vehicle by actual measurement or prediction. The vehicle speed sensor 60 has a plurality of wheel speed sensors that detect wheel speeds of respective wheels, and can be a type which predicts a vehicle speed of an own-vehicle using the output signals of the wheel speed sensors.

The yaw rate sensor 62 is a sensor which detects a yaw rate actually generated in the own-vehicle. The yaw rate sensor 62 has a tuning folk type vibrator so as to be capable of detect a yaw rate of the own-vehicle by detecting distortion generated in the vibrator based on a yaw moment of the own-vehicle.

Steering angle sensor 64 is a sensor which detects as a steering angle an angle at which the steering wheel of the own-vehicle has rotationally operated by a driver of the own-vehicle.

As shown in FIG. 1, the following distance control device according to the present embodiment is further equipped with a control permission switch 70 and a mode selection switch 72.

The control permission switch 70 is a switch operated by a driver so as to input information regarding the driver's intension to the following distance ECU 50 as to whether or not to permit the following distance control.

The mode selection switch 72 is a switch operated by the driver in order to select a control mode, which the driver desires, from among a plurality of control modes previously prepared for controlling a following distance.

The plurality of control modes are prepared with respect to a following time, which is a time period which is assumed to elapse from a moment when a front-vehicle passes a certain position until the own-vehicle passes the certain position. In this case, the plurality of control modes can be defined as including a long time control mode, a short time control mode and a medium time control mode. In the long time control mode, a following distance is controlled so that a relatively long following distance is maintained between a front-vehicle and an own-vehicle so as to a relatively long following time is achieved. In the short time control mode, a following distance is controlled so that a relatively short following distance is maintained between a front-vehicle and an own-vehicle so as to a relatively short following time is achieved. The medium time control mode positions between the long time control mode and the short time control period.

Next, a description will be given of a software structure of the following distance control apparatus according to the present embodiment.

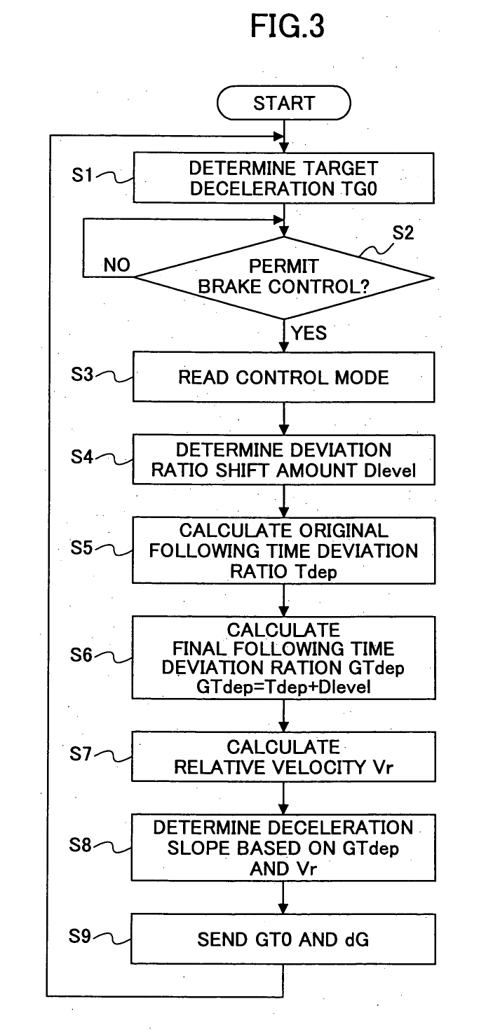

In order to execute the above-mentioned following distance control, various programs are previously stored in a ROM of the computer of the following distance ECU 50. FIG. 3 is a flowchart showing conceptually the contents of a deceleration control program which is one of the programs stored in the ROM of the following distance ECU 50. However, in FIG. 3, illustration of parts of the deceleration control program that are not necessary for understanding the present invention are omitted.

In the deceleration control program, first in step S1 (hereinafter, the word “step” will be omitted for the sake of simplification), a target deceleration GT0 of the own-vehicle is calculated based on following distance information. A relationship between the following distance information and the target deceleration GT0 is stored previously in the ROM in the form of a map, a table, etc., and the target deceleration GT0 corresponding to the current following distance information is determined as the current target deceleration GT0 according to the relationship.

Here, the “following distance information” can be defined as including both a relative velocity Vr of the front-vehicle with respect to the own-vehicle and the above-mentioned following time T.

Here, the “relative velocity Vr” indicates that, if a sign thereof is plus, the following distance tends to increase as the own-vehicle goes away from the front-vehicle. On the other hand, the “relative velocity Vr” indicates that, if a sign thereof is minus, the following distance tends to decrease as the own-vehicle approaches the front-vehicle.

In other words, the relative velocity Vr is an example of a physical amount representing whether the current relative position of the own-vehicle with respect to the front-vehicle is shifted in a direction in which the own-vehicle approaches the front-vehicle or in a direction in which the own-vehicle goes away from the front-vehicle. That is, the relative velocity Vr represents a direction of relative movement of the own-vehicle with respect to the front-vehicle, and also represents a degree of the movement.

On the other hand, the “following time T” indicates that comparing a case where the following time T with a case where the following time T is short in the same vehicle speed, the following distance is longer as the following time T is longer. If it is desirable to consider an appropriate following distance as a variable value determined according to a vehicle speed rather than a fixed value. Thus, in order to determine whether an appropriate following distance is long or short, it is necessary to refer to the current vehicle speed each time. On the other hand, using the following time T alone permits expression of a degree of attention to be paid by the driver of the own-vehicle to avoid a collision of the own-vehicle with a front-vehicle. Thus, the following time T is a parameter which can represents the driver's feel more accurately.

In other words, the following time T is an example of a physical amount representing whether an actual relative position of the own-vehicle with respect to the front-vehicle is shifted from a target relative position in a direction in which the own-vehicle approaches the front-vehicle or a direction in which the own-vehicle does away from the front-vehicle. That is, the following time T represents a deviation of the relative position of the own-vehicle with respect to the front-vehicle, and also represents a degree of the deviation.

Next, in S2, it is determined whether a brake control should be permitted for a deceleration control of the own-vehicle. This determination may be performed so that the brake control is permitted when all of the following conditions are satisfied; (a) the radar 40 is tracking a front-vehicle, that is, a condition that there exists a front-vehicle to be followed by the own-vehicle; (b) a probability that the front-vehicle being tracked by the radar 40 is running on the same lane with the own-vehicle is greater than a set value; and (c) the following distance detected by the radar 40 is equal to or smaller than a brake control permission distance which is set so that the following distance must be below the brake control permission distance so as to permit the brake control.

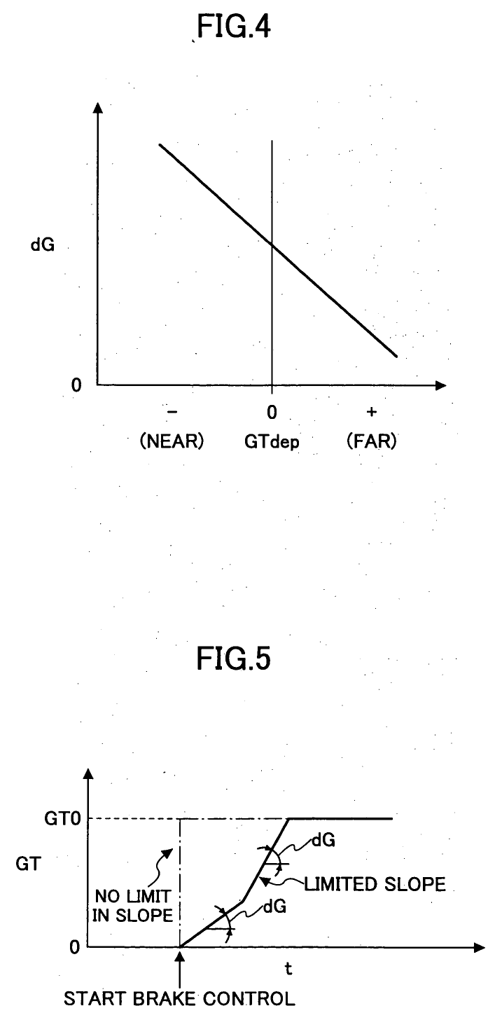

Subsequently, a deceleration slope dG, which the own-vehicle aims, is determined by performing the process of S3 through S8. Roughly explaining, the deceleration slope dG is determined according to a relationship as indicated in FIG. 4 based on the relative velocity Vr and a final following time deviation ratio GTdep. The relationship is previously stored in the ROM.

It should be noted that FIG. 4 indicates the relationship between the final following time deviation ratio GTdep and the deceleration slope dG for a certain value of the relative velocity Vr as a downward-sloping line. If the tendency of increase in the following distance increases as the relative velocity Vr increases, the line in the graph of FIG. 4 shifts so that the deceleration slope dG decreases. On the other hand, if the tendency of decrease in the following distance increases as the relative velocity Vr decreases, the line in the graph of FIG. 4 shifts so that the deceleration slope dG increases.

The “final following time deviation ratio Gtdep” is calculated by adding a deviation ratio shift amount Dlevel to an original following time deviation ratio Tdep.

The original following time deviation ratio Tdep can be obtained by dividing a value obtained by subtracting a target following time TT from a real following time TR by the target following time TT. The original following time deviation ratio Tdep means that, if it is equal to zero, the target following distance is just achieved. Additionally, the original following time deviation ratio Tdep means that the own-vehicle is closer to the front-vehicle, if it is a negative value, than the position at which the target following distance is achieved, and the own-vehicle is farther from the front-vehicle, if it is a positive value, than the position at which the target following distance is achieved.

The “real following time TR” can be obtained by dividing a real following distance D by a real vehicle velocity Vn of the own-vehicle. On the other hand, the “target following time TT” is determined by a control mode selected by the driver of the own-vehicle through the mode selection switch 72. After all, the original following time deviation ratio Tdep represents a degree that the real following time TR cannot achieve the target following time TT. It should be noted that a function of the deviation ratio shift amount will be mentioned later. FIG. 5 is a graph showing meanings of the target deceleration GT0 and the deceleration slope dG. The target deceleration GT0 is a target value of a normal value of the deceleration performed by the brake control, while the deceleration slope dG is a value of the target deceleration GT during a transition period during which a real deceleration GR increases from zero and reaches the target deceleration GT0, that is, a value used for defining a transition value of the target deceleration GT. The graph of FIG. 5 shows by double dashed chain lines a change in the target deceleration GT with respect time when the deceleration slope dG is not limited, that is, in a case where an increase in the real deceleration GR is permitted immediately after the target deceleration GT0 is set. Furthermore, the graph of FIG. 5 shows by solid lines a change in the target deceleration GT with respect time when the deceleration slope dG is limited according to the present embodiment, that is, in a case where the deceleration slope dG is permitted to change depending on the relative velocity Vr and the following time deviation ratio Tdep as mentioned above.

Therefore, according to the present embodiment, it is easy to smoothly change the real deceleration GR of an own-vehicle during the deceleration control of the own-vehicle.

A description will now be given of the meaning of the deviation shift amount Dlevel.

When the control mode selected by the driver is the short time control mode, it is desirable to determine the deceleration slope dG so as to be sensitively responsive to a change in the original following time deviation ratio Tdep. If the deceleration slope dG is determined in the above-mentioned manner, the tendency in the control of the following distance D without an overshoot (a phenomenon that the real following distance exceeds the target following distance toward the shortage side due to an actual value-of the deceleration amount exceeding an ideal value) is intensified.

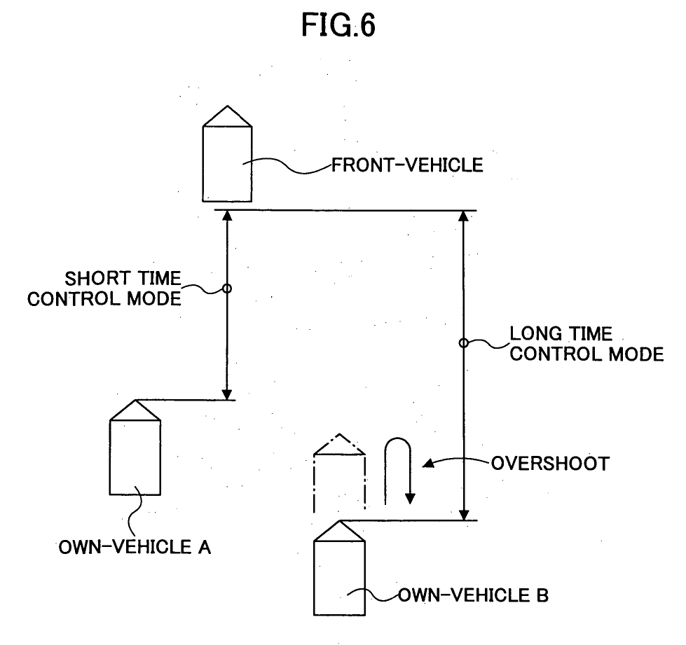

Illustrated conceptually on the left side of FIG. 6 is a condition in which the deceleration of the own-vehicle A is performed according to the short time control mode in the relationship with the front-vehicle. In this example, the following distance between the own-vehicle A and the front-vehicle is controlled without an overshoot.

On the other hand, if the control mode selected the driver of the own-vehicle is the long time control mode, it is desirable to determine the decelerating slope dG so as to be insensitively responsive to a change in the original following time deviation ratio Tdep. If the decelerating slope dG is determined in the above-mentioned manner, the tendency in the control of the following distance D with an overshoot is intensified.

Illustrated conceptually on the right side of FIG. 6 is a condition in which the deceleration of the own-vehicle B is performed according to the long time control mode in the relationship with the front-vehicle. In this example, the following distance between the own-vehicles B and the front-vehicle is controlled with an overshoot.

As explained above, it is desirable to change the control characteristic of the following distance according to a kind of the control mode, and in order to realize the change, the deviation ratio shift amount Dlevel is provided in the present embodiment.

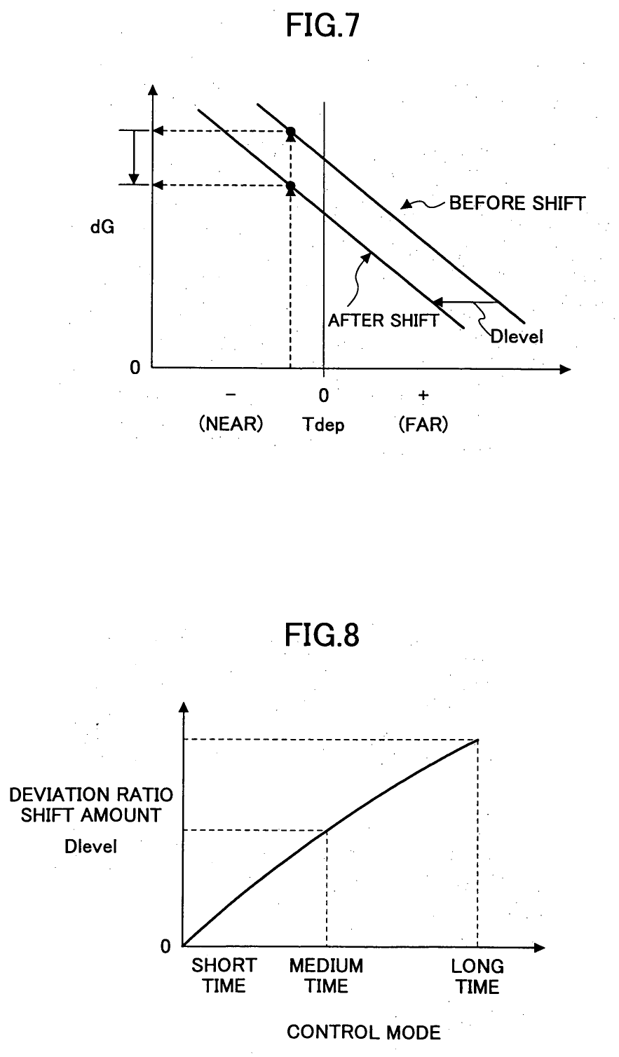

In a graph of FIG. 7, there are shown, in parallel, two lines each having a downward slope. According to the upper-side line, a large deceleration slope is provided with respect to the same original following time deviation ratio Tdep, while according to the lower-side line, a small deceleration slope is provided with respect to the same original following time deviation ratio Tdep.

Accordingly, the control characteristics of the following distance can be matched to the kind of the control mode in a flexible manner by selecting the upper-side line with respect to the original following time deviation ratio Tdep if the short time control mode is selected, and selecting the lower-side line with respect to the original following time deviation ratio Tdep if the short time control mode is selected.

Thus, in the present embodiment, the relationship (shown in FIG. 4) between the final following time deviation ratio GTdep and the deceleration slope dG is defined by using the upper-side graph as a reference, and the final following time deviation ratio GTdep is obtained by adding the deviation ratio shift amount Dlevel to the original following time deviation ratio Tdep, thereby virtually realizing the lower-side graph.

In order to realize the above-mentioned process, in the process of S3 of FIG. 3, the control mode selected by the driver through the mode selecting switch 72 is read.

Then, in S4, the deviation ratio shift amount Dlevel is determined according to the control mode selected at this time in accordance with a relationship that is shown in the graph of FIG. 8 and is previously stored in the ROM. The deviation ratio shift amount Dlevel is determined that as to be zero when the short time control mode is selected, a medium value when the medium time control mode is selected and a maximum value when the long time control mode is selected.

Thereafter, in S5 of FIG. 3, the real following time TR is calculated by dividing the real following distance D detected by the radar 40 by the real vehicle velocity Vn detected by the vehicle speed sensor 60. The original following time deviation ratio Tdep is calculated based on the relationship between the calculated real following time TR and the target following time TT.

Then, in S6, the final following time deviation ratio GTdep is calculated by adding the determined deviation ratio shift amount Dlevel to the calculated original following time deviation ratio Tdep.

Thereafter, in S7, the relative velocity Vr is calculated by dividing a value obtained by subtracting the last value of the real following distance D from the current value of the real following distance D by a time period of one cycle of the control cycle. However, if the time period of one cycle is constant over a plurality of times of the control cycle, the subtracted value may be used as the relative velocity Vr for the sake of convenience of the calculation.

Then, in S8, the deceleration slope dG at this time is determined as mentioned above according to the calculated final following time deviation ratio GTdep and the calculated relative velocity Vr.

Thereafter, in S9, the determined deceleration slope dG and the calculated target deceleration GT0 at this time are sent to the brake ECU 30 through the engine ECU 32. The brake ECU 30 calculates a deceleration which should be achieved by the brake 10 in each control cycle based on the received deceleration slope dG and the received target deceleration GT, and controls the brake 10 so as to achieve the calculated deceleration.

Then, one cycle of execution of the deceleration control program, that is, one cycle of the deceleration control is ended, and, thereafter, a next control cycle will be stated.

In the present embodiment, if it is determined that a deceleration of the own-vehicle is needed during the execution of the following distance control, the deceleration control is performed by the brake 10 from the beginning without performing a process of increasing a change gear ratio of the transmission to increase an effect of the engine brake. This is because it is possible to change the deceleration slope during the execution of the deceleration control so as to match to a run state of the own-vehicle and a drive feel of the driver even though the brake 10 is used as a deceleration apparatus.

However, in the present embodiment, a degree of opening of the throttle is minimized, if necessary, so that the deceleration by the brake 10 is not prevented due to an output of the engine. The decrease in the throttle opening is achieved by the throttle actuator controlled by the engine ECU 32.

In the present embodiment, the own-vehicle goes away from the front-vehicle at a position at which the target following distance is achieved, and the own-vehicle is accelerated so as to catch up the-front-vehicle if the relative velocity Vr is a negative value. This acceleration is achieved by controlling, for example, a degree of throttle opening as an acceleration control amount to accelerate the own-vehicle. A program for performing the acceleration control is also stored in the above-mentioned following distance ECU 50.

According to the acceleration control program, a target acceleration AT0 is determined in the same manner as the process of S1 of FIG. 3. If the sign of the target acceleration AT0 is plus, it means that a real acceleration AR of the own-vehicle is increased, and if the sign is minus, it means that the real acceleration is decrease. An absolute value of the target acceleration AT0 is determined in the same manner as the above-mentioned target deceleration GT0. An acceleration control amount of the own-vehicle is determined based on the thus-determined target acceleration AT0. In this regard, the acceleration control amount is determined in accordance with a rule which does not permit an undershoot of the real following distance based on the difference between the target acceleration AT0 and the real acceleration AR irrespective of the selected control mode.

A description will be given of a second embodiment of the present invention.

A hardware structure of a following distance control apparatus according to the second embodiment of the present invention is the same as that of the above-mentioned first embodiment, but a software structure of the second embodiment differs from the first embodiment at least in the deceleration control program. Therefore, in the present embodiment, the deceleration control program will be explained in detail, and elements the same as the elements of the first embodiment are given the same reference numerals or the same designations so as to omit descriptions of other elements.

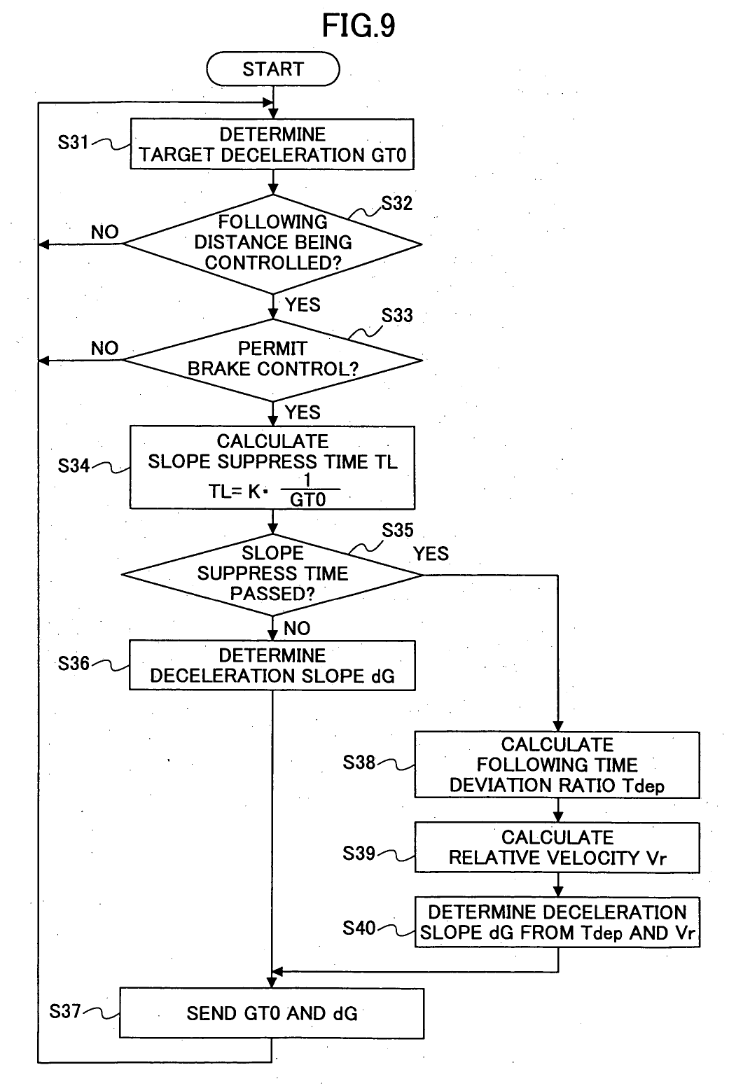

FIG. 9 is a flowchart which shows conceptually the contents of the deceleration control program executed by a computer of the following distance control apparatus according to the present embodiment.

In the deceleration control program, in S31, the target deceleration GT0 is first calculated in the same manner as the process of the above-mentioned S1. Next, in S32, it is determined whether or not the following distance control is currently being performed. For example, it is determined whether or not the control permission switch 70 has been operated so as to permit the execution of the following distance control.

Then, in S33, it is determined whether or not to permit the brake control in the same manner as the process of the above-mentioned S2. That is, it is determined whether or not it is needed to decelerate the own-vehicle by the brake 10 so as to optimize the following distance.

In the present embodiment, in the initial period of the deceleration control by the brake 10, a setup of the deceleration slope dG is limited so that the deceleration slope dG is smaller than that during other periods. That is, the deceleration slope dG is suppressed during the initial period of the deceleration control, and the initial period is referred to as a slope suppress time TL.

Thereafter, in S34, a length of slope suppress time TL is set so that the slope suppress time TL becomes shorter as the calculated target deceleration GT0 is larger. The length of the slope suppress time TL can be calculated, for example, using a product of a coefficient k and a reciprocal of the target deceleration GT0.

Then, in S35, it is determined from the start time of the brake control whether or not the calculated slope suppress time TL has passed.

If it is determined that the slope suppress time TL has not passed, the determination of S35 is negative (NO). Thus, in S36, the deceleration slope dG is determined in accordance with a predetermined rule. The rule is defined to determine the deceleration slope dG to vary based on a vehicle state amount (for example, a vehicle speed of the own-vehicle) and following distance information (for example, the relative velocity Vr, the following time deviation ratio Tdep (equal to the above-mentioned original following time deviation ratio Tdep)) within a range where the deceleration slope dG does not exceed a value which can be taken after the slope suppress time TL has passed.

Thereafter, in S37, the calculated target deceleration GT0 and the determined deceleration slope dG are sent to the brake ECU 30 through the engine ECU 32.

Then, one cycle of the control according to the deceleration control program is completed. On the other hand, if it is determined that the slope suppress time TL has passed, the determination of S35 is affirmative (YES).

Thus, in step S38, the following time deviation ratio Tdep is calculated in the same manner as the process of the above-mentioned S5. Thereafter, in S39, the relative velocity Vr is calculated in the same manner as the process of the above-mentioned S7. Then, in S40, the deceleration slope dG is determined based on the calculated following time deviation ratio Tdep and the calculated relative velocity Vr in the same manner as the process of the above-mentioned S8. Thereafter, the routine proceeds to S37.

Then, one cycle of the control by the deceleration control program is completed.

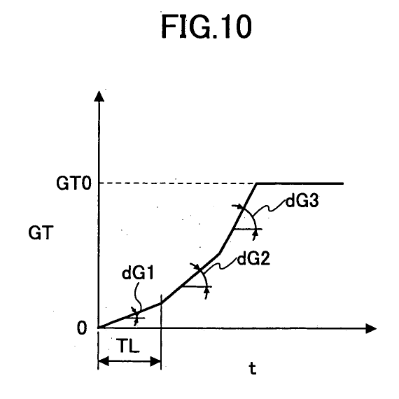

FIG. 10 is a graph showing conceptually an example of a change in the deceleration slope dG with respect to time during a series of deceleration control operations performed by execution of the deceleration. control program. Before the slope suppress time TL passes, the deceleration slope dG is determined as a small deceleration slope dG1. After the slope suppress time TL has passed, the deceleration slope dG, which matches both the current following time deviation ration Tdep and the relative velocity dAG, is determined. In this example, the deceleration slope dG is first determined to be a deceleration slope dG2 which is greater than the deceleration slope dG, and, then, to be a deceleration slope dG3 which is greater than the deceleration slope dG2.

A description will be given of a third embodiment of the present invention.

A hardware structure of a following distance control apparatus according to the third embodiment of the present invention is the same as that of the above-mentioned first and second embodiments, but a software structure of the third embodiment differs from the first and second embodiments at least in the deceleration control program. Therefore, in the present embodiment, the deceleration control program will be explained in detail, and elements the same as the elements of the first and second embodiments are given the same reference numerals or the same designations so as to omit descriptions of other elements.

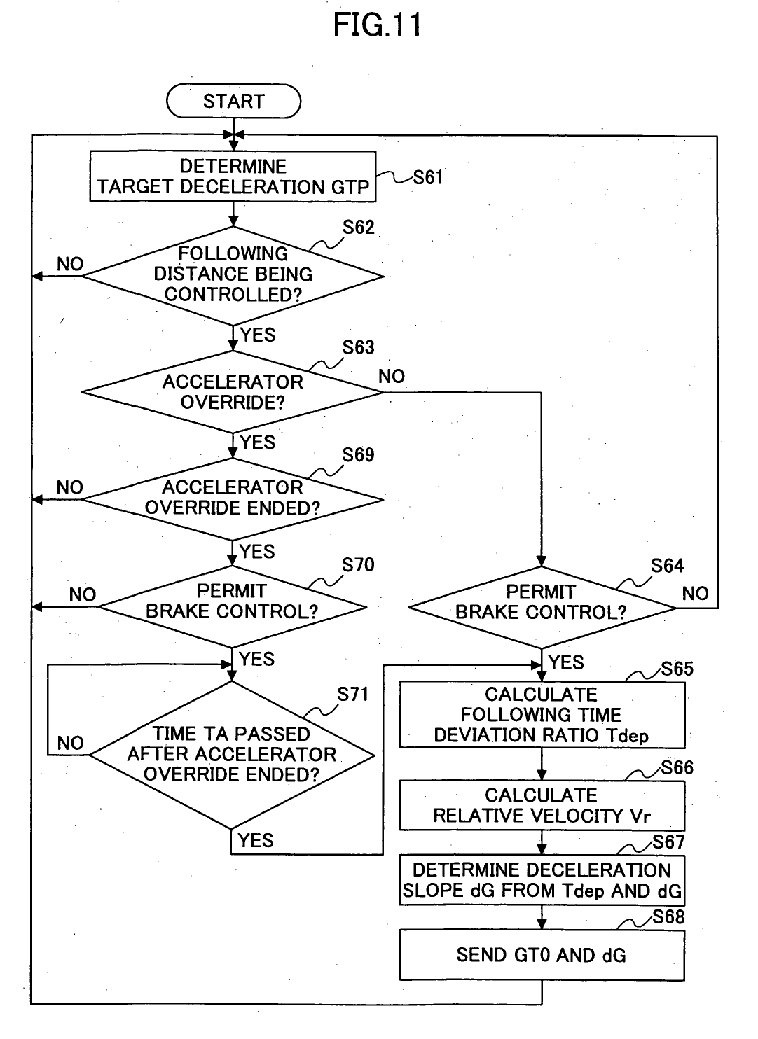

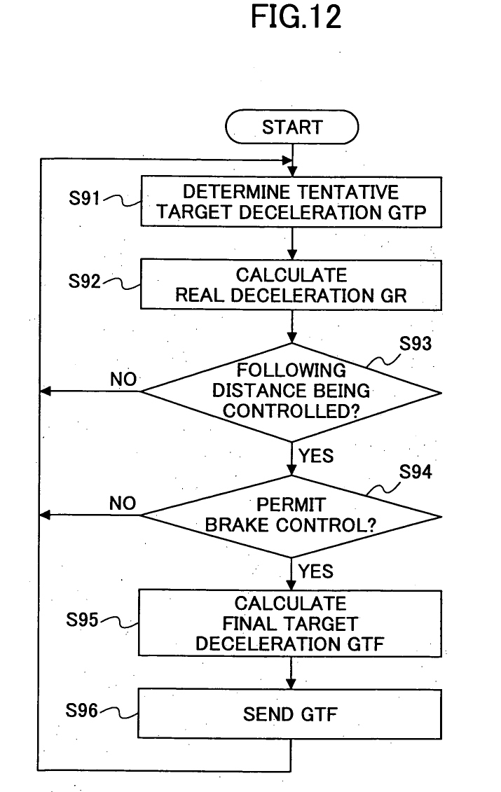

FIG. 11 is a flowchart which shows conceptually the contents of the deceleration control program executed by the computer of the following distance ECU 50 in a following distance control apparatus according to the third embodiment of the present invention.

In the deceleration control program, first in S61, the target deceleration GT0 is calculated in the same manner as the above-mentioned S31. Next, in S62, it is determined whether or not the following-distance control is currently being performed.

Then, in S63, it is determined whether or not a priority is given to an acceleration according to the driver's operation over the following distance control by detecting a depression of an acceleration pedal (this is an example of a part operated by a driver to accelerate an own-vehicle) by the driver during execution of the following distance control. That is, it is determined whether or not an accelerator override has been performed.

If it is determined that the accelerator override has not been performed, the determination of S63 is negative (NO), and the routine proceeds to S64. In S64, it is determined whether or not to permit the brake control in the same manner as the process of S33. That is, it is determined whether or not it is needed to decelerate the own-vehicle by the brake 10 so as to optimize the following distance.

If it is determined that the brake control should not be permitted at this time, that is, if it is determined that the own-vehicle should not be decelerated, the determination of S64 is negative (NO) and one cycle of the control according to the deceleration control program is ended. On the other hand, if it is determined that the brake control should be permitted, that is, if it is determined that the own-vehicle should be decelerated, the determination of S64 is positive (YES). In this case, the routine proceeds to S65.

In S65, the following time deviation ratio Tdep is calcualted in the same manner as the process of the above-mentioned S38. Thereafter, in S66, the relative velocity Vr is calculated in the same manner as the process of the above-mentioned S39. Then, in S67, the deceleration slope dG is determined based on the calculated following time deviation ratio Tdep and the calculated relative velocity Vr in the same manner as the process of the above-mentioned S40. Thereafter, in S68, the calculated target deceleration GT0 and the determined deceleration slope dG are sent to the brake. ECU 30 through the engine ECU 32 in the same manner as the process of the above-mentioned S37.

Then, one cycle of the control according to the deceleration control program is completed.

Although the case where an accelerator override was not started was explained above; if the accelerator override was started, the determination of step S63 becomes affirmative (YES), thereby proceeding S69. In S69, it is determined whether or not the started accelerator override has been ended, that is, whether or not the depression of the acceleration pedal is canceled by the driver.

If it is determined that the accelerator override has not been ended at this time, the determination of S69 is negative (NO), and, then, one cycle of the control according to the deceleration control program is completed. On the other hand, if it is determined that the accelerator override has been ended at this time, the determination of S69 is affirmative (YES), and it is determined, in S70, whether to permit the brake control in the same manner as the process of the above-mentioned S64.

If it is determined that the brake control should not be permitted at this time, the determination of S70 is negative (NO), and one cycle of the control according to the deceleration control program is ended. On the other hand, if it is determined that the brake control should be permitted at this time, the determination of S70 is affirmative (YES). In this case, in S71, it is waited until a setting time TA has passed after the after the accelerator override was ended. Therefore, in this period, the brake control is prevented form being actually performed even though the brake control is permitted. Therefore, immediately after the end of the accelerator override, a rapid deceleration and a rapid acceleration of the own-vehicle can be prevented, which results in prevention of an acceleration and deceleration shock of the own-vehicle.

After the setting time TA has passed, the determination of S71 becomes affirmative (YES) thereby proceeding to S65. Consequently, the own-vehicle is decelerated under the deceleration slope dG which matches both the following time deviation ratio Tdep and the relative velocity Vr. Then, one cycle of the control according to the deceleration control program is ended.

A description will be given of a fourth embodiment of the present invention.

A hardware structure of a following distance control apparatus according to the fourth embodiment of the present invention is the same as that of the above-mentioned first and second embodiments, but a software structure of the fourth embodiment differs from the first and second embodiments at least in the deceleration control program. Therefore, in the present embodiment, the deceleration control program will be explained in detail, and elements the same as the elements of the first and second embodiments are given the same reference numerals or the same designations so as to omit descriptions of other elements.

FIG. 12 is a flowchart which shows conceptually the contents of the deceleration control program executed by the computer of the following distance ECU 50 in a following distance control apparatus according to the fourth embodiment of the present invention.

In the deceleration control program, first in step S91, the target deceleration GT0 is calculated as a tentative target deceleration GTP in the same manner as the process of the above-mentioned S31. Next, in S92, a real deceleration GR of the own-vehicle is calculated. The real deceleration GR can be obtained by acquiring by subtracting the last value Vn−1 from the current value Vn of the vehicle speed V detected by the vehicle speed sensor 60, or by detecting directly using a deceleration sensor.

Thereafter, in S93, it is determined whether or not the following distance control is currently being performed in the same manner as the process of the above-mentioned S32. Then, in S94, it is determined whether or not to permit the brake control in the same manner as the process of the above-mentioned S33.

Thereafter, in S95, a final deceleration GTF is calculated by feeding back the above-mentioned calculated real deceleration GR. Specifically, for example, based on the relationship between the real deceleration GR and the tentative target deceleration GTP, the final target deceleration GTF is calculated as a suitable deceleration for performing a PD control or a PID control of a next real deceleration GR of the own-vehicle.

For example, in order to carry out the PD control of the real deceleration GR, the final target deceleration GTF is calculated using a sum of a proportional term and a differential term, the proportional term being represented by, a product of a proportion coefficient Kp and a value obtained by subtracting the tentative target deceleration GTP from the real deceleration GR, the differential term being represented by a product of a differential coefficient Kd and a time differential value of a value obtained by subtracting the tentative target deceleration GTP from the real deceleration GR.

On the other hand, in order to carry out the PID control of the next real deceleration GR, the final target deceleration GTF is calculated using a sum of the above-mentioned proportional term, the above-mentioned differential term and an integral term represented by a product of an integral coefficient Ki and a time integrated value of a value obtained by subtracting the tentative target deceleration GTP from the real deceleration GR.

Then, in step S96, the thus-calculated final target deceleration GTF is sent to the brake ECU 30 through the engine ECU 32. Then, one cycle of the control according to the deceleration control program is ended.

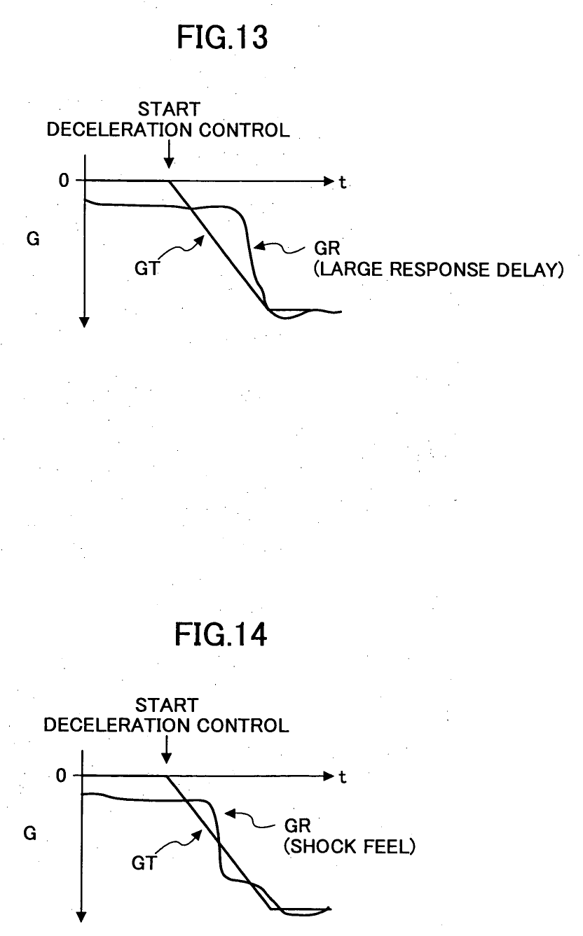

In the meantime, FIG. 13 and FIG. 14 show conceptually graphs of two examples of a change in the real deceleration GR with respect to time, respectively, in a case where a series of deceleration control operations (brake control) is performed according to a calculation of the target deceleration GT on the assumption that the real velocity GR is zero.

The example shown in FIG. 13 indicates that there is possibility of existence of a long time during which the real velocity GR cannot follow the target deceleration FT when there is a large delay in a response of behavior of the own-vehicle with respect to the brake control. On the other hand, the example shown in FIG. 14 indicates that there is a possibility of rapid fluctuation of the real velocity GR with respect to the target deceleration GT as a center when there is no large delay in a response of behavior of the own-vehicle with respect to the brake control. In the latter example, there is a possibility that passengers of the own-vehicle feel a shock due to the fluctuation of the real velocity GR during a deceleration.

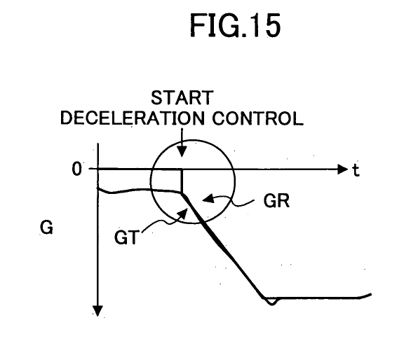

However, unlike the above-mentioned two cases, according to the present embodiment, a series of the deceleration control operations (brake control) is performed by calculating the target deceleration GT for the first cycle of the control without assuming that the real velocity is zero. Therefore, according to the present embodiment, as conceptually indicated in the graph of FIG. 15, the real deceleration GR accurately follows the target deceleration GT from the initial period of the deceleration control, and, thereby, it becomes easy to avoid the response delay of the real velocity GR and a feel of shock during a deceleration.

A description will be given of a fifth embodiment of the present invention.

A hardware structure of a following distance control apparatus according to the fifth embodiment of the present invention is the same as that of the above-mentioned first and second embodiments, but a software structure of the fifth embodiment differs from the first and second embodiments at least in the deceleration control program. Therefore, in the present embodiment, the deceleration control program will be explained in detail, and elements the same as the elements of the first and second embodiments are given the same reference numerals or the same designations so as to omit descriptions of other elements.

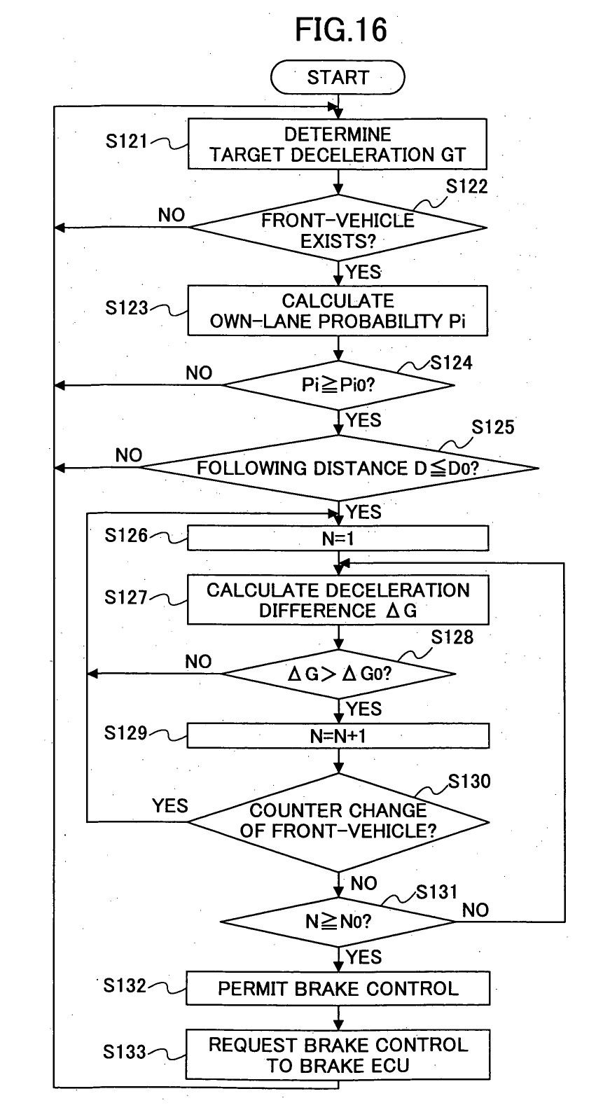

FIG. 16 is a flowchart which shows conceptually the contents of the deceleration control program executed by the computer of the following distance ECU 50 in a following distance control apparatus according to the fifth embodiment of the present invention.

In the brake control permission determination program, first in S121, the target deceleration GT is determined in the same manner as the process of the above-mentioned S31. Next, in S122, it is determined based on the output signal of the radar 40 whether or not a front-vehicle (a moving object) with respect to the own-vehicle. If it is determined that there is no front-vehicle, the determination of S122 is negative (NO), and the routine returns to S121. On the other hand, if it is determined that there exists a front-vehicle, the determination of S122 is affirmative (YES), and the routine proceeds to S123.

In S123, an own-lane probability Pi, which is a probability of existence of a front-vehicle in the same lane in which the own-vehicle exists, is calculated. The own-lane probability Pi is calculated in accordance with a predetermined relationship between the own-lane probability Pi and a distance at which a position of the front-vehicle acquired by the radar 40 shifts from the own-lane in a direction of a width of the lane.

Thereafter, in S124, it is determined whether or not the calculated own-lane probability Pi is equal to or greater than a threshold value Pi0. If it is determined that own-lane probability Pi is smaller than the threshold value Pi0, the determination of S124 is negative (NO), and the routine returns to S121. On the other hand, if it is determined that own-lane probability Pi is equal to or greater than the threshold value Pi0, the determination of S124 is affirmative (YES), and the routine process to S125.

In S125, it is determined whether or not the following distance D detected by the radar 40 is smaller than a brake control permission distance D0. The brake control permission distance D0 is set on the assumption that it is unnecessary to decelerate the own-vehicle by the brake control if the following distance D is longer than the brake control permission distance D0, but it is necessary to decelerate the own-vehicle by the brake control if the following distance D is equal to or smaller than the brake control permission distance D0. If it is determined that the following distance D is not equal to or smaller than the brake control permission distance D0, the determination of S125 is negative (NO), and the routine returns to S121. On the other hand, if it is determined that the following distance D is equal to or smaller than the brake control permission distance D0, the determination of S125 is affirmative (YES), and the routine proceeds to S126.

In step S126, a number of times N is initialized to 1. Thereafter, in step S127, the deceleration difference ΔG is calculated. The deceleration difference ΔG is calculated by subtracting the target deceleration GT from the real deceleration GR. Then, in S128, it is determined whether or not the calculated deceleration difference ΔG is larger than a threshold value ΔG0. If it is determined that the calculated deceleration difference ΔG is not larger than the threshold value ΔG0 at this time, the determination of S128 is negative (NO), and the routine returns to S126 so as to enter a next control cycle. On the other hand, if it is determined that the calculated deceleration difference ΔG is larger than the threshold value ΔG0 at this time, the determination of S128 is affirmative (YES), and the routine proceeds to S129 where the number of times N is incremented by 1.

Thereafter, in S130, it is determined whether or not there was a counterchange of the front-vehicle, that is, whether or not the front-vehicle acquired by the radar 40 in the current control cycle is different from the front-vehicle acquired by the radar 40 in the last control cycle. For example, using the above-mentioned discriminating function of a front-vehicle by the radar 40, it is determined whether or not the front-vehicle acquired by the radar 40 in the current control cycle is different from the front-vehicle acquired by the radar 40 in the last control cycle (for example, whether or not a distance between a pair of reflectors of the front-vehicle acquired by the radar 40 in the current control cycle is the same as that of the last control cycle).

If it is determined that there was a counterchange of the front-vehicle, the determination of S130 is affirmative (YES), and the routine returns to S126 where the number of times N is reset. On the other hand, if it determined that there was no counterchange of the front-vehicle, the determination of S130 is negative (NO), and the routine proceeds to S131.

In S131, it is determined whether or not a current value of the number of times N is equal to or greater than a threshold value N0. That is, it is determined whether or not the control cycles, which satisfies a condition that the deceleration difference ΔG is larger than the threshold value ΔG0 without a counterchange of the front-vehicle, continued for N0 times. If it is determined that current value of the number of times N is not equal to or larger than the threshold value N0, the routine returns to S127 and enter a next control cycle. On the other hand, if it is determined that current value of the number of times N is equal to or larger than the threshold value N0, the determination of S131 is affirmative (YES), and the routine proceeds to S132.

In S132, an execution of the brake control is permitted. Thereafter, in S133, a request for the brake control is made to the brake ECU 30. Consequently, the own-vehicle is decelerated so that the target deceleration GT is achieved by the brake ECU 30.

Then, one execution of the brake control permission determination program is ended.

Thus, according to the present embodiment, an execution of the brake control is permitted only when the target object (target for tracking) for the own-vehicle is continuously the same front-vehicle during a period in which the number of times N is equal to or larger than the threshold value N0. Therefore, an unnecessary execution of the brake control is avoidable unlike a case where the execution of the brake control is permitted based on the fact that the number of times N is equal to or larger than the threshold value N0 even though the front-vehicle was counterchanged in the corresponding time period.

A description will be given of a sixth embodiment of the present invention.

A hardware structure of a following distance control apparatus according to the sixth embodiment of the present invention is the same as that of the above-mentioned first embodiment, but a software structure of the sixth embodiment differs from the first embodiment at least in the deceleration control program. Therefore, in the present embodiment, the deceleration control program will be explained in detail, and elements the same as the elements of the first embodiment are given the same reference numerals or the same designations so as to omit descriptions of other elements.

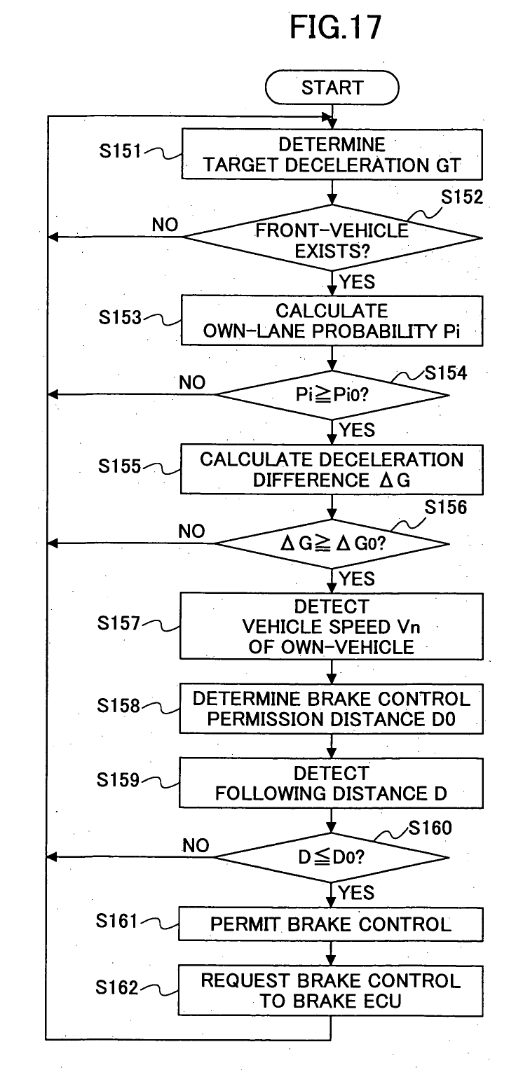

FIG. 17 is a flowchart which shows conceptually the contents of the deceleration control program executed by the computer of the following distance ECU 50 in a following distance control apparatus according to the sixth embodiment of the present invention.

In the brake control permission determination program, first in S151, the target deceleration GT is determined in the same manner as the process of the above-mentioned S121. Next, in S122, it is determined based on the output signal of the radar 40 whether or not a front-vehicle (a moving object) with respect to the own-vehicle. If it is determined that there is no front-vehicle, the determination of S152 is negative (NO), and the routine returns to S151. On the other hand, if it is determined that there exists a front-vehicle, the determination of S152 is affirmative (YES), and the routine proceeds to S153.

In S153, an own-lane probability Pi is calculated in the same manner as the process of the above-mentioned S123. Thereafter, in S154, it is determined whether or not the calculated own-lane probability Pi is equal to or greater than a threshold value Pi0. If it is determined that own-lane probability Pi is smaller than the threshold value Pi0, the determination of S154 is negative (NO), and the routine returns to S151. On the other hand, if it is determined that own-lane probability Pi is equal to or greater than the threshold value Pi0, the determination of S154 is affirmative (YES), and the routine process to S155.

In step S155, the deceleration difference ΔG is calculated in the same manner as the process of the above-mentioned S127. Then, in S156, it is determined whether or not the calculated deceleration difference ΔG is larger than a threshold value ΔG0. If it is determined that the calculated deceleration difference ΔG is not larger than the threshold value ΔG0 at this time, the determination of S156 is negative (NO), and the routine returns to S151. On the other hand, if it is determined that the calculated deceleration difference ΔG is larger than the threshold value ΔG0 at this time, the determination of S56 is affirmative (YES), and the routine proceeds to S157.

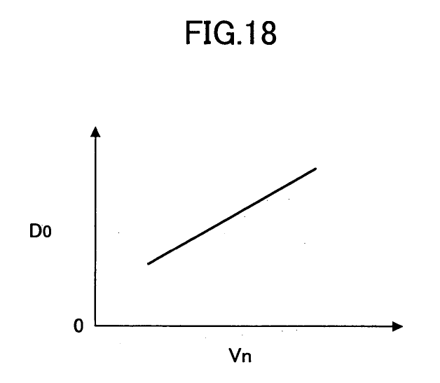

In S157, a vehicle speed Vn of the own-vehicle is detected by the vehicle speed sensor 60. Thereafter, in S158, the above-mentioned brake control permission distance D0 is determined based on the detected vehicle speed Vn. The brake control permission distance D0 is determined so as to be increased together with the vehicle speed Vn as shown in the graph of FIG. 18.

Therefore, in the present embodiment, since the brake control permission distance D0 increases as the vehicle speed Vn increases, a start time of the brake control is made earlier, which results in an improvement in a reliability of the following distance control and also in a sense of ease of the driver.

Then, in S159, the following distance D is detected by the radar 40. Thereafter, in S160, it is determined whether or not the detected following-distance D is equal to or smaller than the above-mentioned brake control permission distance D0.

If it is determined that the following distance D is not equal to or smaller than the above-mentioned brake control permission distance D0, the determination of S160 is negative (NO), and the routine returns to S151.

On the other hand, if it is determined that the following distance D is equal to or smaller than the above-mentioned brake control permission distance D0, the determination of S160 is affirmative (YES), and the routine proceeds to S161 where the brake control is permitted. Thereafter, in S162, a request for the brake control is made to the brake ECU 30. Consequently, the own-vehicle is decelerated so that the target deceleration GT is achieved by the brake ECU 30.

Then, one execution of the brake control permission determination program is ended.

A description will be given of a seventh embodiment of the present invention.

A hardware structure of a following distance control apparatus according to the seventh embodiment of the present invention is the same as that of the above-mentioned first embodiment, but a software structure of the seventh embodiment differs from the first embodiment at least in the deceleration control program. Therefore, in the present embodiment, the deceleration control program will be explained in detail, and elements the same as the elements of the first embodiment are given the same reference numerals or the same designations so as to omit descriptions of other elements.

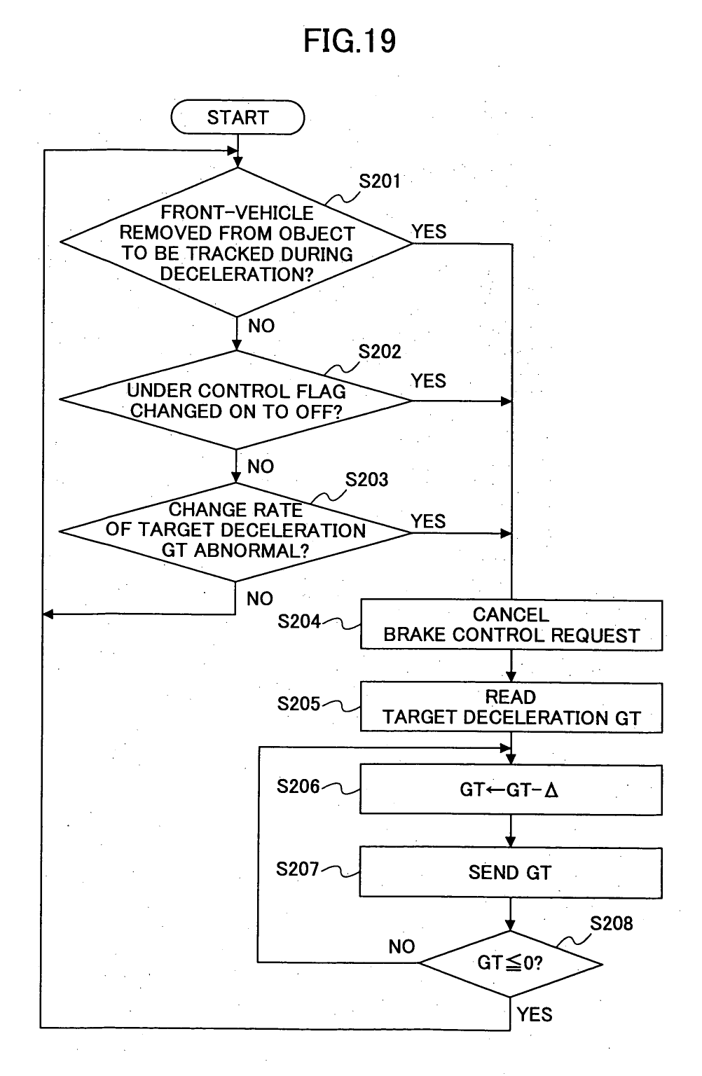

FIG. 19 is a flowchart which shows conceptually the contents of the deceleration control program executed by the computer of the following distance ECU 50 in a following distance control apparatus according to the seventh embodiment of the present invention.

The brake control cancellation program is executed, after the brake control is started, so as to decelerate the own-vehicle. In the brake control cancellation program, it is first determined in S201 whether or not a front-vehicle is released from objects to be tracked by the own-vehicle during deceleration of the own-vehicle. Specifically, it is determined whether or not the front-vehicle is released from objects to be tracked by the own-vehicle, and also whether or not an acceleration level of the own vehicle immediately before the release of the front-vehicle is a negative value. If it is determined that the front-vehicle was not released from objects to be tracked by the own-vehicle during deceleration of the own-vehicle, the determination of S201 is negative (NO), and the routine proceeds to S202.

In S202, it is determined whether or not an under control flag is changed from ON to OFF. The under control flag indicates that the control permission switch 70 is ON (the following-distance control is being performed) when it is ON, and the control permission switch 70 is OFF (the following-distance control is not being performed) when it is OFF. The under control flag also changes from ON to OFF when an abnormality occurs in the following distance system (including the following distance control apparatus) that consists of elements related with the following distance control in the own-vehicle.

If it is determined that the under control flag is maintained at ON at this time, the determination of S202 is negative (NO), and the routine proceeds to S203.

In S203, it is determined whether or not a temporal change rate of the target deceleration GT is abnormal. The temporal change rate of the target deceleration GT can be obtained by subtracting the last value GTn−1 from the current value GTn of the target deceleration GT. It is highly possible that the temporal change rate of the target deceleration GT indicates an abnormal value when an abnormality occurs in the following distance control system or an abnormality occurs in a result of detection of a front-vehicle by the radar 40.

If it is determined that the temporal change rate of the target deceleration GT is not abnormal at this time, the determination of S203 is negative (NO), and the routine returns to S201.

If one of the determinations of S201 through S203 is changed to YES while the process of S201 through S203 is repeated as mentioned above, the routine proceeds to S204. In S204, the brake control request is canceled, and, then, a current value of the target deceleration GT is read in S205. Thereafter, in S206, a value obtained by subtracting a setting amount Δ from the read target deceleration GT is determined as a new target deceleration GT.

Then, in S207, the determined target deceleration GT is sent to the brake ECU 30 through the engine ECU 32. Consequently, the brake 10 of the own-vehicle is controlled so that the current target deceleration GT, that is, a deceleration smaller than the previous target deceleration GT is achieved.

Thereafter, in S208, it is determined whether or not the current value of the target deceleration GT is equal to or smaller than zero. If it determined that the current value of the target deceleration GT is not equal to or less than zero, the determination of S208 is negative (NO), and the routine returns to S206. Accordingly, a value obtained by subtracting a setting amount Δ from the current value of the target deceleration GT is determined as a next value of the target deceleration GT.

If the current value of the target deceleration GT becomes equal to or less than zero while the process of S206 through S208 is repeated, the determination of S208 becomes affirmative (YES), and one execution of the brake control cancellation program is ended.

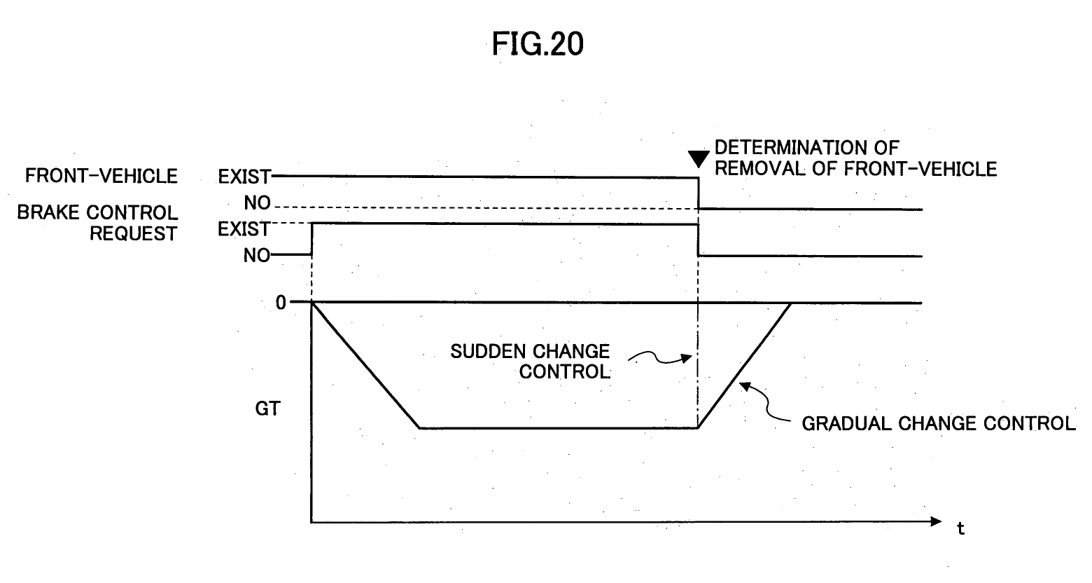

FIG. 20 is a time chart which conceptually represents a temporal change in various status amount from a start time to an end time of a series of deceleration control operations. If a brake control request is made by the following distance ECU 50 in a state where a front-vehicle exists, the target deceleration GT and the deceleration slope dG are determined, for example, in the same manner as the first embodiment and the brake 10 is controlled so as to achieve the target deceleration GT and the deceleration slope dG.

Thereafter, the brake control request is cancelled according to the present embodiment when the front-vehicle goes out of the front of the own-vehicle, an abnormality occurs in the following distance control system or an abnormality occurs in the detection of the front-vehicle by the radar 40. With this cancellation, if the following distance ECU 50 sends the target deceleration GT having a value of zero to the brake ECU 30, the target deceleration GT, which is not zero, is suddenly changed to zero as indicated by “sudden change control” in FIG. 20. Thus, passengers of the own-vehicle may be given a shock due to the sudden release of the brake 10.

On the other hand, in the present embodiment, is the brake control request is cancelled, the target deceleration GT is changed so as to gradually approach zero as indicated by “gradual change control” in FIG. 20. Thus, according to the present embodiment, a shock, which is uncomfortable for passengers of the own-vehicle, does not occur when canceling the brake control.

A description will be given of an eighth embodiment of the present invention.

A hardware structure of a following distance control apparatus according to the eighth embodiment of the present invention is the same as that of the above-mentioned first embodiment, but a software structure of the eighth embodiment differs from the first embodiment at least in the deceleration control program. Therefore, in the present embodiment, the deceleration control program will be explained in detail, and elements the same as the elements of the first embodiment are given the same reference numerals or the same designations so as to omit descriptions of other elements.

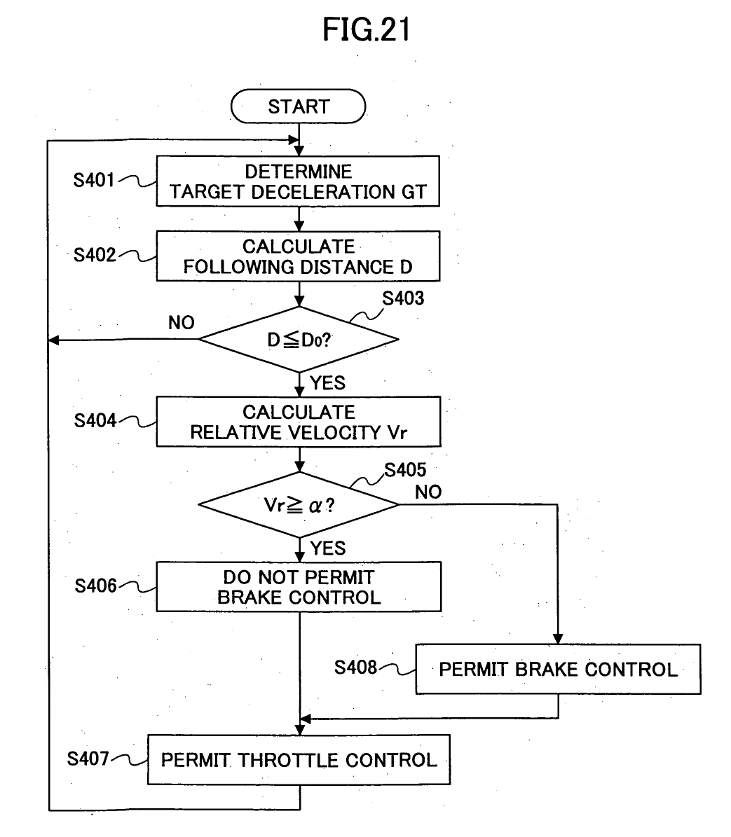

FIG. 21 is a flowchart which shows conceptually the contents of the deceleration control program executed by the computer of the following distance ECU 50 in a following distance control apparatus according to the eighth embodiment of the present invention.

In the deceleration control program, the target deceleration GT of the own-vehicle is first determined, in S401, based on following distance information in the same manner as the process of S3 of FIG. 3. If the target deceleration GT is a positive value, this means that the own-vehicle is to be decelerated. On the other hand, if the target deceleration GT is a negative value, this means that the own-vehicle is to be accelerated.

Next, in S402, the following distance D is detected by the radar 40. Then, in S403, it is determined whether or not the detected following distance D is equal to or smaller than the brake control permission distance D0.

If it is determined that the following distance D is not equal to or smaller than the brake control permission distance D0, the determination of S403 is negative (NO), and the routine returns to S401. On the other hand, if it is determined that the following distance D is equal to or smaller than the brake control permission distance D0, the determination of S403 is affirmative (YES), and the routine proceeds to S401.

In S404, the relative velocity Vr is calculated by subtracting the last value Dn−1 from the current value Dn of the following distance Dn. Thereafter, in S405, it is determined whether or not the calculated relative velocity Vr is equal to or greater than a setting value α which is not a negative value. In other words, it is determined whether or not the front-vehicle, which may caused the following distance D to be equal to or less than the brake control permission distance D0, tends to approach relatively to the own-vehicle.

If it is determined that the relative velocity Vr is equal to or greater than the setting value a at this time, the determination of S405 is affirmative (YES). Thus, the following distance control according to the brake control is not permitted in S406. Then, in S407, the following distance control according to the throttle control is permitted. In this case, the above-mentioned calculated target deceleration GT is sent to the engine ECU 32. Consequently, the engine ECU 32 supplies a signal to the throttle actuator 20 so that the throttle is choked, for example, at a maximum closed position. Therefore, the deceleration control for the following distance control is performed only by the throttle control at this time.

Then, one execution of the deceleration control program is ended.

On the other hand, if it is determined that the relative velocity Vr is not equal to or greater than the setting value α, the determination of S405 is negative (NO), and the routine proceeds to S408 where the following distance control according to the brake control is permitted. In this case, the above-mentioned calculated target deceleration GT is sent to the brake ECU 30 through the engine ECU 32. Consequently, the brake ECU 30 supplies a signal to the brake actuator 12 so that the target deceleration GT is achieved by the brake 10.

Thereafter, the routine proceeds to S407. As a result, at this time, the deceleration control for the following distance control is performed according to both the brake control and the throttle control.

Then, one execution of the deceleration control program is ended. As apparent from the above description, according to the present embodiment, in a case where a third vehicle breaks into a position between the front-vehicle and the own-vehicle and if the driver of the own-vehicle feels that there is no need to decelerated the own-vehicle according to the brake control since the third vehicle is moving at a speed higher than the own-vehicle, a gentle deceleration is performed according to the throttle control alone. Therefore, unlike the case where a strong deceleration is performed according to both the brake control and the throttle control or the brake control alone, an uncomfortable feel is not given to the driver of the own-vehicle.

The present invention is not limited to the specifically disclosed embodiments, and variations and modifications may be made without departing the scope of the present invention.

The present application is based on Japanese priority application No. 2003-9984 filed Jan. 17, 2003, the entire contents of which are hereby incorporated by reference.

What is claimed is:

1. A following distance control apparatus for controlling a following distance, which is a distance between an own-vehicle and a front-vehicle running ahead of the own-vehicle, by controlling a movement of the own-vehicle, the following distance control apparatus comprising:
a sensor provided in the own-vehicle so as to detect the front-vehicle;
a deceleration apparatus that decelerates the own-vehicle; and
a controller that controls said deceleration apparatus based on an output signal of said sensor,
wherein said controller controls said deceleration apparatus according to selected one of a short distance control mode and a long distance control mode, the short distance control mode for controlling an actual value of the following distance to be shorter, the long distance control mode for controlling the actual value of the following distance to be longer; and
said controller also controls said deceleration apparatus so that, when said long distance control mode is selected, an overshoot is permitted more than when said short distance control mode is selected, the overshoot being a phenomenon in which the own-vehicle moves excessively toward a near side of the front-vehicle.

2. The following distance control apparatus as claimed in claim 1, wherein said deceleration apparatus includes at least one of a brake force increasing apparatus for increasing a brake force of the own-vehicle and a drive power decreasing apparatus for decreasing a drive power of the own-vehicle.

3. The following distance control apparatus as claimed in claim 2, wherein said brake force increasing apparatus includes a brake that controls rotation of a wheel of the own-vehicle.

4. The following distance control apparatus as claimed in claim 2, wherein
said own-vehicle comprises:
an engine as a power source, an amount of intake air thereto being controlled in response to a degree of opening of a throttle valve; and
a transmission that transmits an output of the engine to a drive wheel of said own-vehicle, a change gear ratio thereof being variable,
wherein said drive power decreasing apparatus includes at least one of means for decreasing the degree of opening of said throttle valve and means for changing the change gear ratio, so that a level of braking action generated by said engine increases.

5. The following distance control apparatus as claimed in claim 1, wherein:
said short distance control mode and said long distance control mode are set in relation to a target value of a following time that is a predicted time period from a time when said front-vehicle passes a certain point until a time when said own-vehicle passes the certain point;
said short distance control mode includes a short time control mode for controlling the following distance by setting the target value of the following time to a small value; and
said long distance control mode includes a long time control mode for controlling the following distance by setting the target value of the following time to a large value.

6. The following distance control apparatus as claimed in claim 1, wherein said controller includes slope control means for controlling a slope of a deceleration of said own-vehicle so that the slope has a gentle inclination when said long distance control mode is selected, and the slope has a steep inclination when said short distance control mode is selected.

7. The following distance control apparatus as claimed in claim 6, wherein said slope control means includes:
target slope determining means for determining a target slopes which is a target value of the deceleration slope, based on a following time deviation relating amount that relates to a difference between an actual value and a target value of a following time that is a predicted time period from a time when said front-vehicle passes a certain point until a time when said own-vehicle passes the certain point so that an inclination of the target slope decreases as a tendency of said own-vehicle separating from said front-vehicle increases and the inclination of the target slope increases as the tendency of said own-vehicle approaching said front-vehicle increases; and
shifting means for performing at least one of a separating shift and an approaching shift prior to the determination of the target slope by said target slope determining means, the separating shift for shifting the actual value of the following time deviation relating amount in a direction in which said own-vehicle apparently goes away from said front-vehicle when said long distance control mode is selected, the approaching shift for shifting the actual value of the following time deviation relating amount in a direction in which said own-vehicle apparently goes close to said front-vehicle when said short distance control mode is selected.

8. The following distance control apparatus as claimed in claim 7, wherein the following time deviation relating amount includes an amount of difference between the actual value and the target value of the following time.

9. The following distance control apparatus as claimed in claim 7, wherein the following time deviation relating amount includes a following time deviation ratio that is a ratio of an amount of difference between the actual value and the target value of the following time to a target value of the amount of difference.

10. The following distance control apparatus as claimed in claim 1, further comprising means for performing the control of the following distance so that an undershoot, which is a phenomenon of said vehicle going excessively away from said front-vehicle, is not permitted.
